(19) United States
(12) Patent Application Publication
(10) Pub. No.: US 2008/0228431 A1
(43) Pub. Date: Sep. 18, 2008

(54) Method and control device for estimating a rotational speed curve of a shaft of a transmission

(76) Inventors: Manfred Guggolz, Rutesheim (DE); Werner Hilenbrand, Neuffen (DE); Wilhelmus Kok, Winnenden (DE); Hilmar Schmalz, Weil der Stadt (DE); David Ulmer, Filderstadt (DE)

Correspondence Address: KLAUS J. BACH, 4407 TWIN OAKS DRIVE, MURRYSVILLE, PA, 15668, US

(21) Appl. No.: 12/006,807

(22) Filed: Jan. 5, 2008

Related U.S. Application Data
(63) Continuation-in-part of application No. PCT/EP2006/006400, filed on Jun. 30, 2006.

(30) Foreign Application Priority Data
Jul. 9, 2005 (DE) 10 2005 032 225.5

(51) Int. Cl. G01P 3/00

(52) U.S. Cl. 702/147

(57) ABSTRACT

In a method for estimating a rotational speed curve of a shaft of a transmission of a motor vehicle after a synchronizing element which acts on the shaft has been deactivated the subsequent speed of the shaft, that is the curve of the rotational speed is estimated on the basis of the rotational speed of the shaft at the deactivation time and the rotational speed gradient at the deactivation time, taking into account a characteristic value (F) which is dependent on an activation period needed for the synchronizing element to accelerate the during activation of the synchronizing element, thereby providing for a particularly precise estimation of the rotational speed curve of the shaft.

This is a Continuation-In-Part Application of international application PCT/EP2006/006400 filed Jun. 30, 2006 and claiming the priority of German application 10 2005 032 225.5 filed Jul. 9, 2005.

### BACKGROUND OF THE INVENTION

The invention relates to a method for estimating a rotational speed curve of a shaft of a motor vehicle transmission on the basis of a measured rotational speed and a speed gradient of the shaft at the time of disengagement of the synchronization element.

DE 102 24 064 A1 describes a method for estimating a rotational speed curve of a shaft of a transmission of a motor vehicle after a synchronizing element which acts on the shaft has switched off. In this context, the rotation speed curve of a countershaft of a gear change transmission is estimated after a hydraulically or pneumatically activated countershaft brake has switched off. In the method it is assumed that the countershaft brake has a switch-off dead time, that is to say, after the disengagement is initiated engagement forces continue to act for the duration of the switch-off dead time. For the estimation of the rotational speed curve, the future profile of the rotational speed is therefore estimated on the basis of the rotational speed of the shaft at the switch-off time with the rotational speed gradient at the switch-off time.

A precise estimation of the rotational speed curve is necessary in order to be able to carry out gear changes in the transmission comfortably and safely. This applies in particular to automated transmissions without synchronizing devices for each particular gear, that is to say what are referred to as unsynchronized transmissions. A target gear can be engaged only if a differential rotational speed at a shift element of the target gear is not too high. Since both the synchronizing element and the shift element have dead times, the times necessary to activate or deactivate the shift element and the synchronizing element for a comfortable and safe gear change occur only on the basis of an estimation of the rotational speed curve of a shaft of the transmission.

It is the present object of the invention to provide a method and a control device which permit a particularly precise estimation of the rotational speed curve of the shaft.

### SUMMARY OF THE INVENTION

In a method for estimating a rotational speed curve of a shaft of a transmission of a motor vehicle after a synchronizing element which acts on the shaft has been deactivated the subsequent speed of the shaft, that is the curve of the rotational speed is estimated on the basis of the rotational speed of the shaft at the deactivation time and the rotational speed gradient at the deactivation time, taking into account a characteristic value (F) which is dependent on an activation period needed for the synchronizing element to accelerate the during activation of the synchronizing element, thereby providing for a particularly precise estimation of the rotational speed curve of the shaft.

The gradient of the rotational speed of the shaft however is apparent only after the synchronizing element has been switched off. It depends on a rotational speed gradient of a shaft in a time range around a deactivation time of the synchronizing element, in particular the rotational speed gradient at the deactivation time, and also to a high degree during the deactivation period of the synchronizing element. This applies in particular if a pneumatically, hydraulically or electromechanically activated multiplate brake is used as the synchronizing element. If the synchronizing element is activated only briefly, it is possible, for example, for the value of the gradient to still rise to a high degree after the synchronizing element has been deactivated since the gradient at the switch-off time does not yet show the braking effect of the synchronizing element. The dependence of the characteristic value on the activation period can be stored, for example, in a characteristic curve. It is also possible for the characteristic value to be stored as a function of a further variable, for example a temperature of the transmission, in a characteristic diagram. The characteristic value can also be determined from the activation period by means of a stored function.

The average gradient which occurs after the synchronizing element has been deactivated can be estimated very precisely by taking into account a characteristic value which is dependent on a activation period of the synchronizing element. Therefore, a particularly precise estimation of the rotational speed curve is possible on the basis of a measured rotational speed value in a time range of the deactivation time, in particular the rotational speed at the deactivation time.

The transmission is embodied in particular as an automated, unsynchronized gear change transmission. By means of the method it is possible, for example, to estimate the rotational speed curve of an input shaft or of a countershaft of the transmission, that is, of shafts which are not directly connected to an output shaft of the transmission for rotation therewith.

The synchronizing element can either brake a shaft of the transmission with respect to the transmission housing or cause the rotational speeds of two shafts to be approximated to one another. For example, the countershaft can be braked against the housing or the countershaft can be decelerated or accelerated with respect to the main shaft. The necessary torques can be generated for example by means of a frictionally locking connection established hydraulically, pneumatically or electromagnetically.

The gradient is acquired, for example, by measuring a rotational speed of a control device of the gear change transmission at various times and acquiring the time gradient using the differences in rotational speed which are obtained from the measured rotational speeds and the time intervals between the measurements. Furthermore, further methods which are known to a person skilled in the art can be used to determine rotational speeds and rotational speed gradients. In addition, the gradient can be smoothed over a plurality of measured values, by means of a suitable method, for example a low-pass filter.

In one embodiment of the invention, the rotational speed curve is estimated on the basis of the measured rotational speed of the shaft and an assumed gradient which is obtained from a product of the acquired rotational speed gradient and the aforesaid characteristic value. A rotational speed value at a specific time, which occurs a particular time period after the time at which the measured rotational speed was determined, is estimated by adding the product of the aforesaid time period and the assumed gradient to the measured rotational speed. The characteristic value can be determined, for example, by means of a stored characteristic curve as a function of the activation time of the synchronizing element.

It is also possible, for example, to obtain the assumed gradient from the sum of the acquired rotational speed gradient and the characteristic value. Likewise, the assumed gradient can be obtained, for example, from a characteristic diagram as a function of the acquired rotational speed gradient and the characteristic value. Furthermore, further methods of taking into account the characteristic value can be implemented.

In one embodiment of the invention, the dependence of the characteristic value on the activation time of the synchronizing element is adapted on the basis of rotational speed profiles which actually occur. An adaptation of the characteristic value is therefore carried out. To do this, the estimated rotational speed curve is compared with the actually occurring rotational speed curve and the characteristic value is adapted in such a way that an estimation of the curve with the adapted characteristic value is at least closer to the actual curve. If, for example, the characteristic value is stored in a characteristic curve, the characteristic curve is adapted.

As a result, component variations between transmissions and changes in the transmission or of individual components such as, for example, the synchronizing element, during the service life of the transmission can be compensated for. Precise estimations of the rotational speed curves are therefore possible for various transmissions over their entire service life.

In one embodiment of the invention, the characteristic value is dependent on a temperature of the transmission. In particular, the characteristic value which is used for the estimation is always higher than a temperature-dependent minimum value. The characteristic value is dependent, for example, on a temperature of a transmission oil. The characteristic value, and in particular the minimum value, are, for example, higher at low temperatures than at high temperatures. The temperature dependence is noticeable in particular at very low temperatures of less than 0° C.

The invention will become more readily apparent from the following description and from the drawings. Exemplary embodiments of the invention are illustrated in simplified form and explained in more detail on the basis of the accompanying drawings:

### BRIEF DESCRIPTION OF THE DRAWINGS

FIG. 1 shows a drive train of a motor vehicle with an automatic change-speed transmission with a synchronizing element,

FIG. 2 shows a characteristic curve which is used for the estimation and which is plotted over the engagement time of the synchronizing element, and

FIG. 3 shows a characteristic curve in which a minimum for the characteristic value is plotted over a temperature of the transmission.

### DESCRIPTION OF PARTICULAR EMBODIMENT

According to FIG. 1, a drive train 10 of a motor vehicle (not illustrated) has a drive motor 14 which is controlled by a control device 16.

The drive motor 14 can be connected by means of an output shaft 13 and a friction clutch 12 to a transmission input shaft 11 arranged coaxially with respect to the output shaft 13 of an automated, unsynchronized, gear change transmission 19, what is referred to as a dog clutch transmission. The clutch 12 and the gear change transmission 19 are actuated by a control device 49. The control device 49 has a signal transmitting connection to actuator elements (not illustrated) of the clutch 12 and of the gear change transmission 19. The control device 49 can therefore open or close the clutch 12 and carry out gear changes in the gear change transmission 19. The control device 49 also has a signal transmitting connection to a rotational speed sensor 53 and to a temperature sensor 54. The rotational speed of a countershaft 22 can be measured by means of the rotational speed sensor 53, and the temperature of a transmission oil can be measured by means of the temperature sensor 54.

The gear change transmission 19 is embodied as what is referred to as a two group transmission. A series transmission in the form of a split group 17 is arranged connected in a rotationally fixed fashion to the transmission input shaft 11. A main transmission 18 is arranged downstream of the split group 17.

The transmission input shaft 11 can be operatively connected by means of the split group 17 via two different gearwheel pairings 20, 21 to the countershaft 22 which is arranged parallel to the transmission input shaft 11. The gearwheel pairings 20, 21 have different transmission ratios. Fixed wheels 23, 24, 25 for the third, second and first gear of the main transmission 18 are arranged in rotationally fixed fashion on the countershaft 22. The fixed wheels 23, 24, 25 respectively intermesh with associated freely moving wheels 26, 27, 28 which are rotatably arranged on a main shaft 29 which is arranged coaxially with respect to the transmission input shaft 11. The freely moving wheel 26 can be connected, by means of a slide sleeve 30, and the freely moving wheels 27 and 28 by means of a slide sleeve 31, to the main shaft 29 in a rotationally fixed and positively locking fashion.

A synchronizing element in the form of a transmission brake 52 is arranged on the countershaft 22 and can be actuated by the control device 49. The transmission brake 52 is embodied as a multiplate brake which can be activated pneumatically and which can brake the countershaft 22 against a housing of the gear change transmission 19. The rotational speed of the countershaft 22 and thus also the rotational speed of the transmission input shaft 11 can be reduced selectively by means of the transmission brake 52.

A slide sleeve 41 of the split group 17 and the slide sleeves 30, 31, 39 of the main transmission 18 can be respectively activated using shift rods 42, 43, 44, 45. A positively locking connection between the associated shift elements and the main shaft 29 can therefore be established or interrupted. The shift rods 42, 43, 44, 45 can be activated using an actuator element in the form of a pneumatic shift actuator 48 which is controlled by the control device 49.

The converted torque and the rotational speed of the drive motor 14 are transmitted from the main shaft 29 by means of a drive shaft 32 to an axle transmission 33 which, in a manner known per se, transmits the rotational speed in identical or different components via two output driveshafts 34, 35 to the drive wheels 36, 37.

The sequence of a gear change from an original gear into a target gear is described in detail in DE 102 24 064 A1. The content of DE 102 24 064 A1, in particular the description of the sequence of the gear changes is incorporated herewith into the disclosure of the present application.

When a target gear is engaged, a difference in rotational speed between the main shaft 29 and the freely moving wheel 26, 27, 28 which is assigned to the target gear must not be too large. The rotational speed of the countershaft 22 must therefore be moved close to what is referred to as the synchronous rotational speed. The synchronous rotational speed is the rotational speed of the countershaft 22 which is present after the target gear has been engaged.

In order to determine a deactivation time of the transmission brake 52 and of an actuation time of the shift actuator 48 it is necessary for the profile of the rotational speed of the countershaft 22 to be calculated in advance or estimated after the transmission brake 52 is deactivated.

The control device 49 estimates a rotational speed value at a certain time after the deactivation time of the transmission brake 52 by adding the product of an assumed gradient with the time period between the estimated time and deactivation time to the rotational speed of the countershaft 22 at the deactivation time. The assumed gradient results from the product of the characteristic value which is dependent on the activation period of the transmission brake 52 and the gradient of rotational speed of the countershaft 22 at the deactivation time of the transmission brake 52. The characteristic value is stored in a characteristic curve plotted against the deactivation duration of the transmission brake 52 in the control device 49.

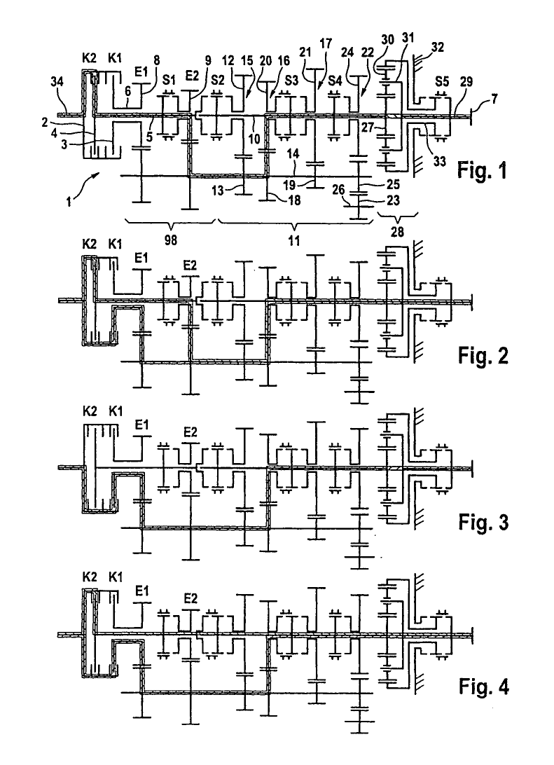

FIG. 2 illustrates an example of such a characteristic curve. Reference points of the characteristic curve are stored in the control device of the gear change transmission. The dimensionless characteristic value (F) and the associated activation time (t_on) are stored in seconds for each reference point. The reference points are illustrated as circles in FIG. 2. For example, the characteristic value of the reference point 60 has the value 1.5 with a activation time of 0.15 sec. For the estimation of the rotational speed curve, a current characteristic value is determined using the current switch-on time of the countershaft brake by linear interpolation between the reference points and is used for the advanced calculation.

The characteristic curve rises from a value of approximately 1.8 at a activation time of 0.06 sec to a value of above 2 with an activation time of 0.085 sec. This maximum value applies for an activation time which corresponds approximately to the activation dead time of the countershaft brake. The activation dead time is in this context the time period between the actuation and the action of the countershaft brake. The rise is due to the fact that for activation times which are shorter than the activation dead time at the deactivation time the pressure on the plates of the countershaft brake has not yet built up. The maximum value in the vicinity of the activation dead time is due to the fact that at the deactivation time, the current gradient does not yet indicate the braking effect of the countershaft brake. The absolute value of the gradient therefore continues to rise during the deactivation dead time of the countershaft brake. For longer activation times than the engagement dead time, the characteristic value drops since then at the deactivation time the gradient is already close to the maximum possible gradient in terms of absolute value. The characteristic value becomes 1 approximately when there is an activation time of 0.205 sec, and it then drops slowly to a value of approximately 0.65 when there is a activation time of 0.33 sec. This value is then also maintained for activation times >0.33 sec.

The characteristic curve is adapted during the operation of the transmission. For this purpose, after the countershaft brake is deactivated, an average gradient of the countershaft rotational speed is determined over a specified time period of, for example, 0.07 sec. The characteristic curve is adapted using the average gradient which is determined in this way and the associated activation time. For this purpose, an adaptation range, which is delineated by “+” in FIG. 2 is present around each reference point with respect to the activation time. For example, the adaptation range for the reference point 60 is delineated by the boundaries 61 and 62. If the associated activation time of the average gradient lies within these boundaries, the characteristic value of the reference point is adapted. The new value is obtained from the following formula:

F_new=F_old*c+F_ave*(1−c),

wherein F_new is the new characteristic value, F_old is the old characteristic value, c is a constant between 0 and 1, for example 0.9, and F_ave is the aforesaid average gradient.

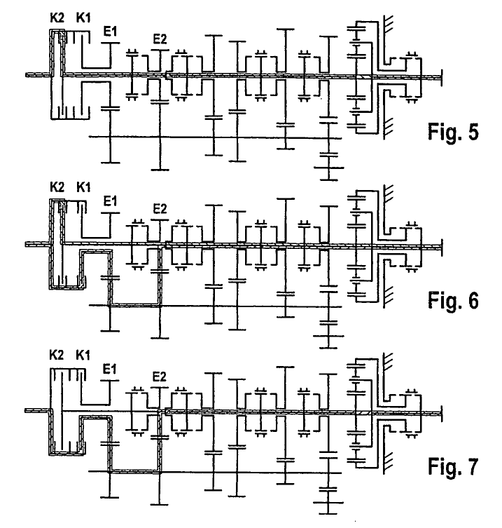

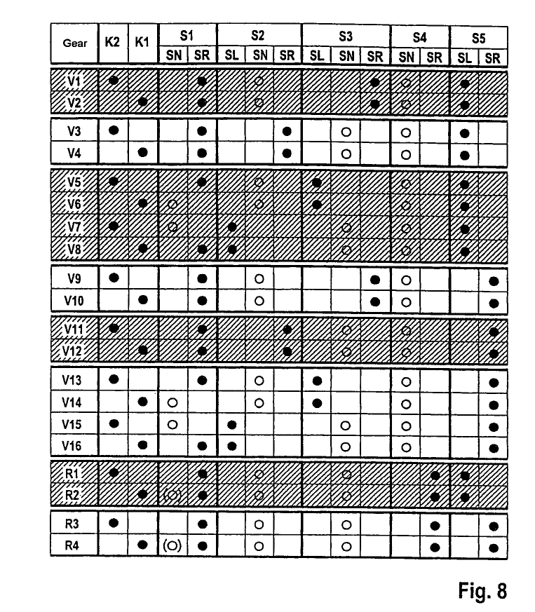

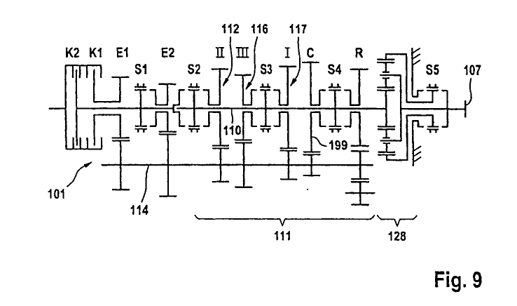

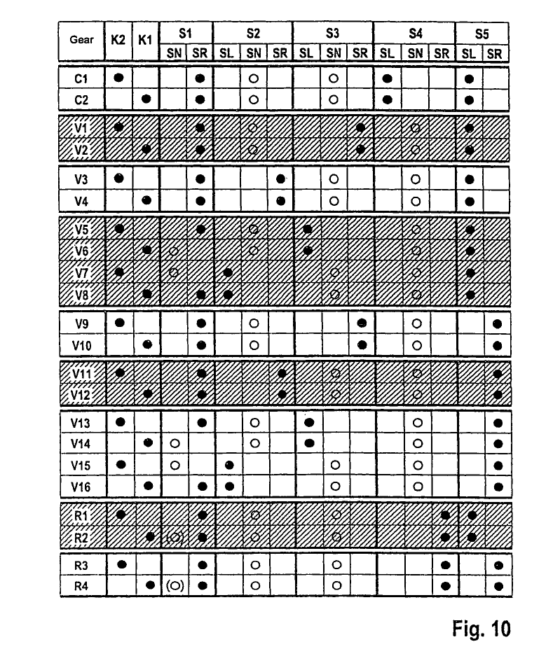

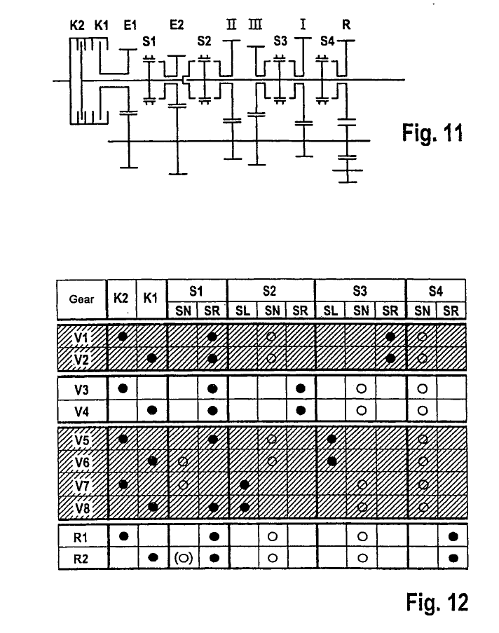

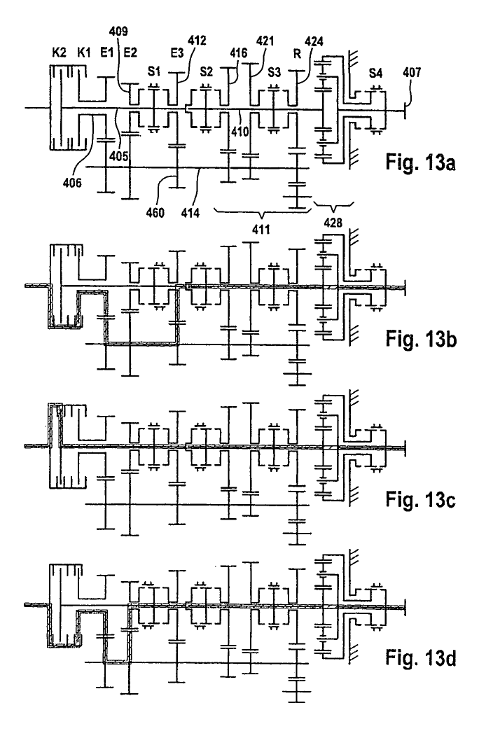

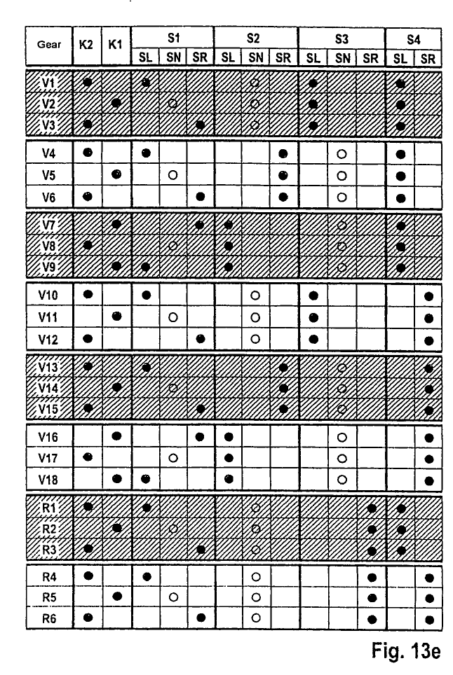

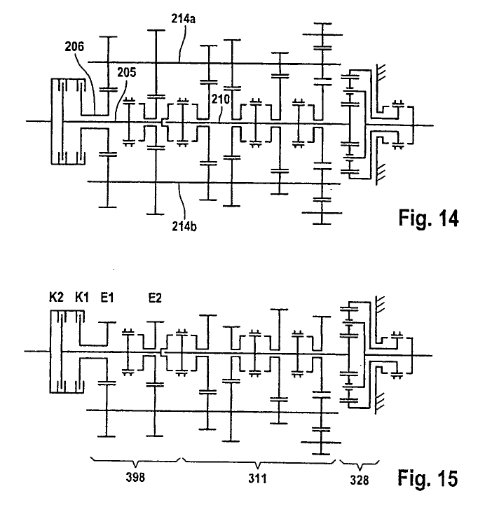

For the characteristic value which is used for the estimation there is a minimum value which is dependent on the temperature of the transmission oil. The lower boundary is likewise stored as a characteristic curve in the control device of the gear change transmission. An exemplary profile of the characteristic curve is stored in FIG. 3. Reference points of the characteristic curve are stored in the control device. The dimensionless characteristic value (F_Min) and the associated temperature (T) are stored in ° C. for each reference point. The temperature reference points (T_Min1, T_Min2, T_Min3) which are illustrated in FIG. 3 can be, for example, the values −50; −10; 40 and the associated minimum values (F_Min1, F_Min2, F_Min3) can have the values 1.2; 1; 0.5. When the control device reads a characteristic value out of the characteristic curve in FIG. 2, it checks whether the value is higher than the minimum value which is associated with the current temperature of the trans-mission oil. If this is the case, the read-out characteristic value is used for the estimation. If the value is lower than the minimum value, the minimum value is used for the estimation.

What is claimed is:

1. A method for estimating a rotational speed curve of a shaft (22) of a transmission (19) of a motor vehicle after a synchronizing element (22) which acts on the shaft (22) has been deactivated at a deactivation time, comprising the steps of: determining the rotational speed and the speed gradient of the shaft (22), estimating a rotational speed curve of the shaft on the basis of the determined rotational speed and the determined rotational speed gradient of the shaft (22) in a time range around the deactivation time of the synchronizing element (52), taking into account a characteristic value (F) which is dependent on a activation period (t_on) of the synchronizing element (52) for the speed adjustment of the shaft.

2. The method as claimed in claim 1, wherein the rotational speed curve is estimated on the basis of the measured rotational speed of the shaft and an assumed gradient which is obtained from a product of the determined rotational speed gradient and said characteristic value (F).

3. The method as claimed in claim 1, wherein the dependence of the characteristic value (F) on the activation period (t_on) of the synchronizing element (52) is adapted on the basis of established rotational speed curves.

4. The method as claimed in claim 1, wherein the characteristic value (F) is dependent on a temperature (T) of the transmission (19).

5. The method as claimed in claim 4, wherein the characteristic value (F) which is used for the estimation is always greater than a temperature-dependent minimum value (F_Min).

6. A control device of a transmission of a motor vehicle provided for estimating a rotational speed curve of a shaft (22) of the transmission (19) after a synchronizing element (52) which acts on the shaft (22) has been deactivated, said control device (49) being provided for estimating the rotational speed curve on the basis of a measured rotational speed and a rotational speed gradient of the shaft (22) in a time range around a deactivation time of the synchronizing element (52) taking into account a characteristic value (F) which is dependent on activation period of the synchronizing element (52).
